(19) United States
(12) Patent Application Publication
(10) Pub. No.: US 2008/0129481 A1
(43) Pub. Date: Jun. 5, 2008

(54) Method and Apparatus for Enhancing Motor Vehicle Turn Signal Awareness

(76) Inventors: Michael Lynn Zumbrunnen, (US); Festus Patrick Trenney, (US)

Correspondence Address: Michael L. Zumbrunnen, 5189 Connemara Dr NE, Rochester, MN, 55906, US

(21) Appl. No.: 11/566,344

(22) Filed: Dec. 4, 2006

(51) Int. Cl. B60Q 1/00

(52) U.S. Cl. 340/457

(57) ABSTRACT

An apparatus for enhancing the awareness of a motor vehicle operator's recent actions regarding the vehicle's intended position and a method to control its operation are disclosed. The apparatus consists of a unit attached directly to a vehicle's nominally 12 volt power adapter to acquire the state of recent actions taken, where these actions comprise from the group consisting of turn signals and brake lights. The operator can choose to only be alerted if a turn signal has not been turned off after a set time or supplement the vehicle's blinker indication by sound or light.

### TECHNICAL FIELD

The present invention relates in general to enhancing cognitive awareness of very recent actions taken by motor vehicle operators, and to enhancing feedback to the operator by operator customization. Still more particularly, the present invention relates to a motor vehicle directional awareness method and apparatus for host motor vehicles.

### BACKGROUND OF THE INVENTION

Motor vehicle turn signal indicators are common on all vehicles ranging from small motorcycles to large semi-trailer tractor trucks. The primary intention of the turn signal indicator is to optically broadcast to near-by vehicles and pedestrians the intentions of the operator to perform a vehicular direction change. Conventional original equipment manufacturers design into the vehicle an automatic turn signal shut-off function for large directional turns yet for small directional turns, rely on the operator's cognitive awareness to manually shut-off the blinker if fully engaged, or to remember to only slightly move and hold the turn signal lever in the direction of turn prior to turning and throughout the slight turn process. Large directional changes, as in performing a 90 degree turn from one road to another, occur quite frequently and the integrated automatic shut-off method performs well. However, the indication of smaller directional changes, as required for lane changing or merging, for example, are not consistently performed correctly, partly because of the reliance on the operator to obey proper turn lever movement instructions. Large or small turns require the operator to activate the turn signal mechanism.

For those instances in which a turn signal indicator is active although the operator has no intentions of a performing a turn, then confusion may exist on the roadway and cause a hazardous driving condition. Similarly, passengers within the host vehicle often get annoyed by a persistent blinker. One may choose to replace the vehicle's flasher with a new flasher or add an interposer beneath the existing flasher so that a much louder clicking sound is emitted. These are to ensure the operator is fully aware of an activated turn signal. Although this method may achieve that goal, the much louder clicking sound is permanent with the vehicle and likely disturbs other drivers of the vehicle and certainly its passengers. For those drivers that are hearing impaired, enhancing the audible strength does not improve their turn signal awareness. Similarly, in situations where there is an abundant amount of traffic noise, loud music, or a hard rain, the likelihood of hearing the supplemental sound is reduced even for those with normal hearing. These deficiencies exist with all schemes exclusively using audio indications, whether initiated by a timer or by distance traveled.

Typically on a vehicle's dashboard are turn signal lights indicating which turn signal is active. The operation of these lights is difficult to discern during daylight hours or by some operators whose physique prohibits easy siting of the lights. Often, the dashboard turn signal lights are not located or illuminated in a manner where they can be seen by the operator's peripheral vision.

Additional deficiencies exist for turn signal systems that do not permit the driver to customize the turn signal awareness system to his preferences. These stagnant systems do not account for vehicles having multiple operators with different preferences or if one operator has variable preferences with time, perhaps due to changing driving conditions.

Prior art turn signal enhancement systems typically require sophisticated installation knowledge as viewed by the customer. Some require splicing into the vehicle's electrical system while others require finding and replacing a flasher unit located somewhere beneath the dash. Wires may protrude from an add-on connections located beneath the dash or to the dash from the electrical harness tap which may be an additional undesirable cosmetic side effect. As such, installation may be beyond the ability or comfort level of the vehicle owner and thereby require an additional expense and inconvenience of professional installation, or more likely, a decision to forego the installation all together.

Similarly, the permanent nature of installed prior art systems mean the systems are confined to the vehicle to which they are installed rather than associated with the operator who may have the need for said systems on multiple vehicles, including rental vehicles, employer vehicles, or other vehicles not under his control or ownership.

### SUMMARY OF THE INVENTION

Accordingly, the present invention relates to a motor vehicle turn signal awareness system comprising of a unit attached directly to a vehicle's nominally 12 volt power adapter to acquire the state of recent actions taken, where these actions comprise from the group consisting of turn signals and brake lights, and to communicate to the operator where the communication comprise from the group chosen by the operator and consists of an alarm indicating excessive turn signal on-time, an audible indication of turn signal operation, and an optical indication of turn signal operation.

An object of the present invention is to overcome the shortcomings of the prior art systems by providing a simple to install motor vehicle directional awareness system. Another object of the present invention is to provide an easy to customize interface so a desired output is realized under changing conditions. A further object of the invention to provide a motor vehicle directional awareness system with physical dimensions small enough to reside within the vehicle's 12 volt power adapter surroundings. It is a still further object of the present invention to provide an improved motor vehicle directional awareness system that can be easily transferable from vehicle to vehicle.

### BRIEF DESCRIPTION OF THE DRAWINGS

The invention will be described in greater detail with reference to the accompanying drawings which represent a preferred embodiment thereof, wherein:

FIG. 1 is an isometric view of a preferred embodiment of a motor vehicle directional awareness system of the present invention;

FIG. 2 is a wiring schematic of a circuit enclosure of the present invention;

FIG. 3 is a logic flow chart of the embodiment shown in FIGS. 1 and 2;

### DETAILED DESCRIPTION

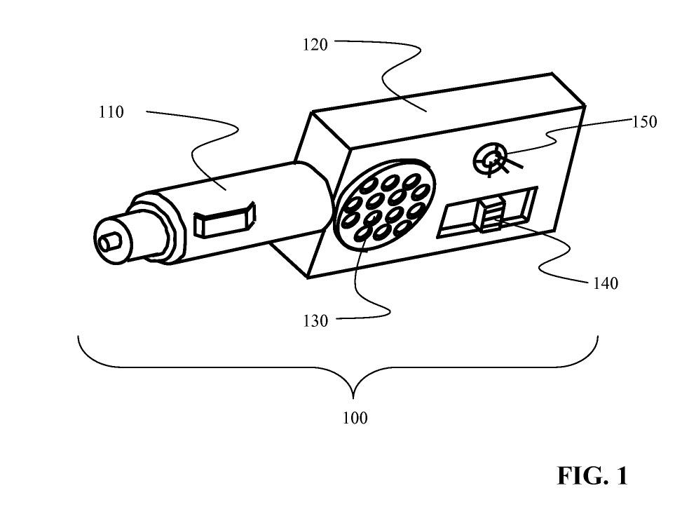

With reference to FIG. 1, a motor vehicle directional awareness system 100, according to an embodiment of the present invention, includes a conventional means 110 to connect to a motor vehicle's 12 volt adapter and an attached circuit enclosure 120 for data capture, computation, and communication with an operator. Said vehicle's 12 volt adapter is also conventionally known as a cigarette lighter socket or DC power socket and its actual voltage may vary somewhat from vehicle to vehicle. The circuit enclosure 120 includes an input device 140 such as a switch, button, or variable resistor thereby allowing certain features to be programmed into the motor vehicle directional awareness system. The purposes of the circuit enclosure 120, although not necessarily operating together, are to amplify the turn signal “blinking” sound initiated by the driver's action of moving a turn signal indicator lever in the upward or downward direction; to mimic the clicking sound of the blinker by a surrogate means such as a blinking light; and to alert the driver the turn signal did not automatically turn itself off. The input device 140 records the driver's output preference of the awareness system by configuring the circuit enclosure 120 to audio amplify mode; light supplement mode; or a mode to operate a buzzer or chime after a certain period of elapse turn signal operation time to indicate the turn signal remains in operation. A typical embodiment employs a variable resistor as the input device 140. For this case, approximately 75 percent of the travel of the sliding switch is apportioned to volume control of the audio output 130 and the remaining 25 percent is divided between a mode to enable a visual output or to enable activation of the alarm only mode.

The audio amplify and light supplement modes substantially mimic the actual turn signals of the vehicle: that is, each are initiated by the driver's actions, terminated by either the automatic shut-off by the vehicle or the driver's manual movement of the turn signal lever back to its neutral position, and the on/off cycles are periodic. However, as will be evidenced later, a slight delay may be present while the device is performing calculations on the acquired voltage data. In alarm mode, the alarm is initiated only after a predetermined time has elapsed and terminated whenever the turn signal turns off or whenever the brake pedal is depressed.

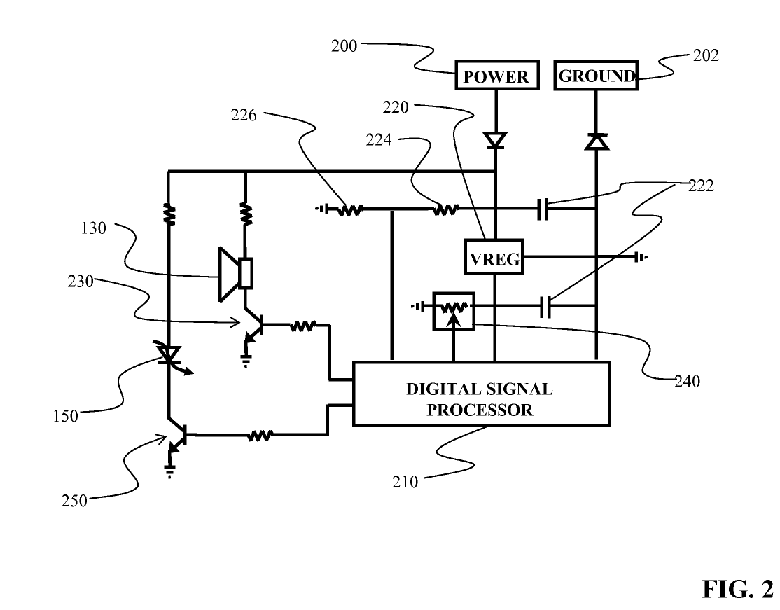

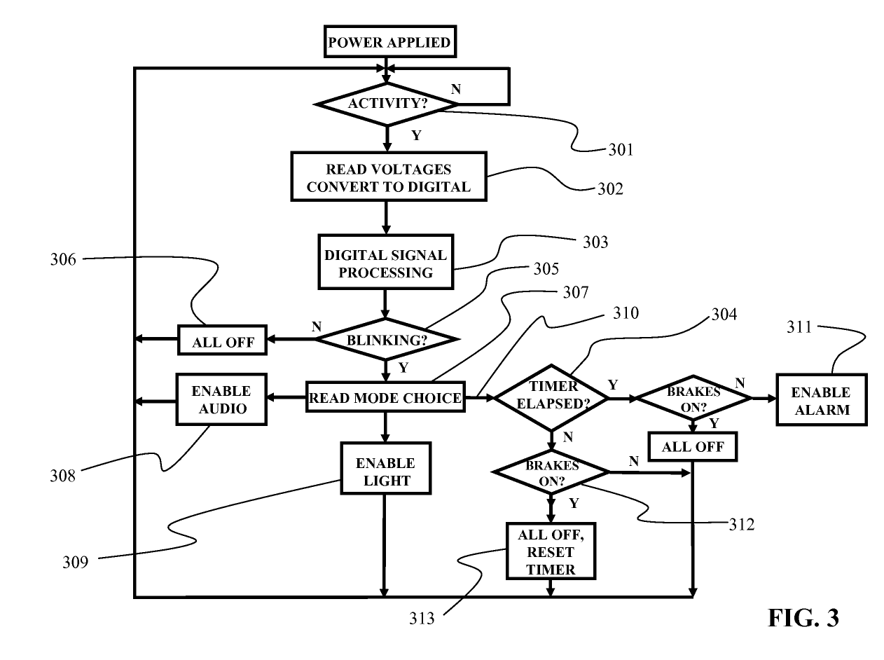

FIG. 2 illustrates schematically the motor vehicle directional awareness system 100. Device power, turn signal, and braking information is obtained directly from the vehicle's 12 volt power socket via positive contact 200 and ground contact 202. As such, installation into any vehicle is easy and obvious even to those with only basic vehicle knowledge. The heart of the motor vehicle directional awareness system is a digital signal processor 210 located in the circuit enclosure 120. The digital signal processor continuously scans and reads the voltage at the power socket and calculates if a periodic voltage drain on the vehicle's electrical system has occurred. The logic flow of the code for the processor is discussed with FIG. 3.

The digital signal processor receives power from the vehicle after its voltage has be regulated to nominally 5 volts by a voltage regulator 220. Capacitors 222 are required for voltage regulator stability. Resistors 224 and 226 are for reducing the vehicle's nominally 12 volts to voltage and current levels within the specifications of the digital signal processor. Values of 2.2 k and 1.0 k Ohms respectively will provide adequate control for most processors. Component selections such as processor model, voltage regulation level, capacitor, and resistor values may be varied for best system optimization.

The output from the digital signal processor controls an audio device 130 and a light device 150 via closing switches 230 and 250 respectively. Such switches are typically NPN or PNP transistors and permit a low current, low power consumption design because the higher current demands of the audio and light devices are serviced directly from the vehicle's 12 volt supply rather than from the processor. If the cost is acceptable, a secondary microprocessor may be chosen which can direct drive the output devices.

The aforementioned audio device can be a chime, buzzer, speaker, or piezospeaker. The driver via mode select switches 140 can select a desired output of the system as previously discussed. Such selection can be done at anytime. The mode select switch 140 can be implemented as a variable resistor 240. The light device 150 can be a convention bulb, LED, VCSEL, or other illuminating device, preferably of low power consumption.

FIG. 3 is a logic flow chart for a motor vehicle directional awareness system 100 shown in FIG. 1 and FIG. 2. The processor code commences automatically upon the observation of a change in voltage 301. Some vehicles have their 12 volt power sockets “on” even though the vehicle is off. Others have the power socket on only if the vehicle is on. To account for all vehicle types, the motor vehicle directional awareness system employs a “sleep” mode where the unit is powered down to negligible power consumption levels if no recent activity is observed. Such inactivity can be due to the lack of brake application, lights turned on, or any other observable power draw on the vehicle's electrical system. The time for wake-up, voltage stabilization and program initialization varies amongst processor models yet typical values on are the order of less than tenths of seconds which for this application has a negligible affect.

Once the main program commences, the device reads the vehicle's voltage at a sampling frequency of approximately 10-50 Hertz (10-50 times per second). This reading rate is substantially greater than the blinker's on/off rate of 1 to 2 blinks per second. The analog signals are converted to digital signals via an on-board analog-to-digital converter 302. Once a digital array of typically 32-64 digitized voltages are available after an elapsed time of 1.3 to 3.2 seconds, the digital signal processing unit 303 begins. This unit filters the data of unwanted noise and signals outside the frequency band of interest. That is, the unit calculates a dominant frequency by performing moving averages, low pass filtering, and Fast Fourier Transforms. As a consequence of the time required to gather and process the data, a slight delay for the first blinking action will occur.

Once the frequency profile of the digital array is known, the processor determines if a blinking action is observed 305. Positive blinking assessment requires the frequency component with the largest power to be within the blinker's frequency range and its power level above a predetermined threshold. Another embodiment of the present invention employs a more sophisticated algorithm to discern between the left and right blinkers. For this embodiment (and if preferred, can be employed for other embodiments), the sampling frequency of the vehicle's voltage can be increased to 50-100 Hz and the number of samples collected increased to 256-512 to discern the left and right asymmetry of an electrical wiring system evident in motor vehicles.

If no blinking action is observed, the output devices are turned off 306 and the program loops back to sample the next set of voltage readings for blinking assessment. If blinking action is indeed observed, then the appropriate action to take is determined from the mode selection module 307. The program branches to enable the audio output 308, the light output 309, or to the alarm 310 branch. In the alarm branch, the processor continuously loops, waiting for the timer to expire 304 or for any braking action 312. A timer counter increments each time the alarm loop is entered. Alternatively, an on-board timer if present on the processor can be implemented. In the embodiment which can discern left from right blinking, separate left and right timers could be employed. If brakes are sensed, then the outputs are disabled 313 and the program loops back to read more data and the timer counter is reset. If the timer elapses before any braking action or before the operator neutralizes the turn signal, then the alarm in enabled 311. The alarm will turn off once the brakes are tapped or the turn signal is neutralized.

Braking action is computed as a load on the vehicle's electrical system equivalent to or greater than that observed for a blinking action and also having no significant higher frequencies as evidenced from wiper motors, air conditioner compressors, or fans.

The process repeats continuously as long as the motor vehicle turn signal awareness system is plugged into the 12 volt socket.

We claim:

1. A motor vehicle positional awareness system comprising
a vehicular nominal 12 volt power adapter integrated with a circuit enclosure to acquire the state of recent actions taken, where said recent actions comprise from the group consisting of turn signals and brake lights,
integrated within said circuit enclosure input and output devices to communicate to the operator where the output communication comprise from the group chosen by the operator and consists of an alarm indicating excessive turn signal on-time, an audible indication of turn signal operation, and an optical indication of turn signal operation,

2. An apparatus of claim 1 where said recent actions taken are determined by frequency spectrum analyses of voltages measured at said power adapter.

3. An apparatus of claim 1 where said circuit enclosure obtains power via said 12 volt power socket.

4. An apparatus of claim 1 where said circuit enclosure powers itself to negligible levels during times of inactivity of said recent actions.

5. An apparatus of claim 1 where said output communication group is chosen by the operator from a group of methods comprising of input switches, slider switches or buttons.

6. An apparatus of claim 1 where said output communication group differentiates between left and right turn signal indicators.

7. An apparatus of claim 1 where said alarm is from the group comprising of audible tones such as beeps, buzzers, chimes, voices, and illumination methods such as LEDs, light bulbs, and vertical cavity surface emitting lasers.

8. An apparatus of claim 1 where said alarm is initiated by timers contained within a processor; left and right turn signal indication timers need not be equal; and the timers are reset whenever braking action occurs.

9. An apparatus of claim 1 where said alarm is terminated whenever the turn signals are returned to their off position or whenever a braking action occurs.

10. An apparatus of claim 1 where said motor vehicle positional awareness system can be removed completely from one vehicle and installed in another vehicle without disassembly or alteration.
